(19) United States
(12) Patent Application Publication
(10) Pub. No.: US 2014/0352807 A1
(43) Pub. Date: Dec. 4, 2014

(54) PRESSURE WASHER WITH HOSE REEL AND MOTOR PUMP ASSEMBLY

(71) Applicant: Active Products Inc., North York (CA)

(72) Inventors: Ming LIU, North York (CA); John SCHMIDER, Etobicoke (CA); Jonathan LOUDON, Toronto (CA); Heather LAM, Toronto (CA)

(21) Appl. No.: 13/906,611

(22) Filed: May 31, 2013

(51) Int. Cl. B08B 3/02

(52) U.S. Cl. CPC B08B 3/026
USPC 137/355.27

(57) ABSTRACT

A pressure washer with hose reel and motor pump assembly. The hose reel and motor pump assembly are disposed in side by side arrangement within a barrel of the pressure washer so as to provide a low centre of gravity while accommodating a suitably long hose, and to provide substantial horizontal weight balance, both of which provide stability to the pressure washer when in use.

### TECHNICAL FIELD

The following relates to a pressure washer and more particularly to a pressure washer having a hose reel and a motor pump assembly disposed within the pressure washer.

### BACKGROUND

Household pressure washers combining a hose reel and a motor pump assembly are generally used for cleaning the exterior of a home or for vehicle cleaning. Generally, the washers are used by homeowners, who store the washer in a first location and transport the washer to a second location during use. As such, the washers may be transportable rather than fixed to a stable structure.

It is generally desirable for a pressure washer to be stable when in use, such that it does not tip or fall over. Various pressure washer designs have been created, some of which take into account the desire for stability. One such design trend incorporates a motor pump assembly within the barrel of a hose reel. PCT patent publication WO2004/069436 to Alto Danmark A/S; European patent publication EP043860 to Wolf-Gerate Gmbh; PCT patent publication WO2001/039900 to Alfred Karcher Gmbh & Co.; German patent publication DE4119907 to Spillecke; and U.S. Pat. No. 3,306,213 to Fritz all disclose pressure washers where the motor pump assembly is mounted within the drum of the hose reel. In these examples, the diameter of the hose reel is at least the width of the motor pump assembly.

U.S. Pat. No. 6,439,475 to Kloepfer et al. discloses a different approach whereby the motor pump assembly is mounted longitudinally in the pressure washer. The motor pump assembly is mounted at the centre of the undercarriage of the pressure washer while the hose reel extends from one side of the frame to the motor pump assembly. On the other side of the motor pump assembly is another reel for an electrical cable or another hose.

### SUMMARY

In one aspect, a pressure washer is provided, the pressure washer comprising: (a) a frame comprising two side walls joined by a barrel, the barrel comprising a substantially vertical divider defining a first chamber and a second chamber of said barrel, the dividing wall having an aperture disposed therethrough; (b) a fluid inlet for receiving fluid; (c) a motor pump assembly disposed within said first chamber, said motor pump assembly in fluid communication with said fluid inlet, said motor pump assembly operable to pressurize said fluid and output pressurized fluid to a pump outlet; and (d) a hose reel disposed within said second chamber, said hose reel being rotatable about an axis coaxial with said aperture of said dividing wall, said hose reel having an aperture in fluid communication with said pump outlet, said aperture adapted to permit a hose to be coupled thereto, said hose reel and said motor pump being disposed transversely to one another.

### BRIEF DESCRIPTION OF THE DRAWINGS

The features of the invention will become more apparent in the following detailed description in which reference is made to the appended drawings wherein:

FIG. 1 is a front left perspective view of an embodiment of a pressure washer;

FIG. 2 is a front right perspective view of the pressure washer;

FIG. 3 is a right side view of the pressure washer;

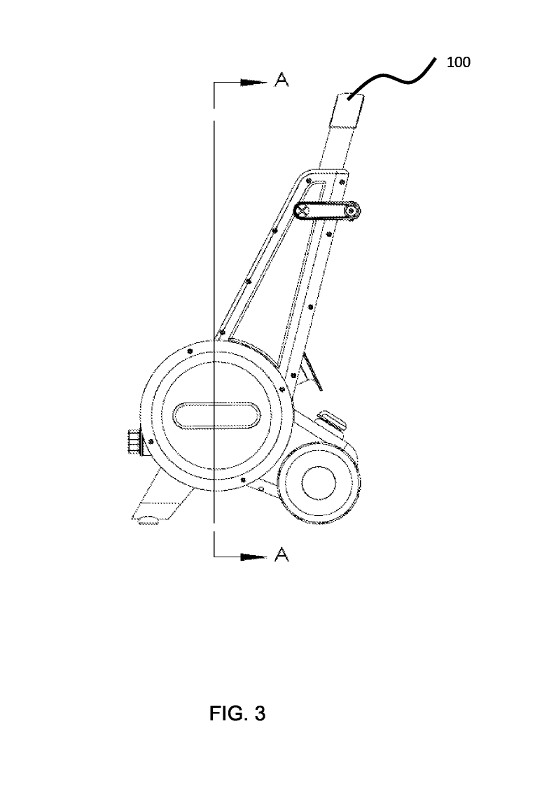

FIG. 4 is a left side view of the pressure washer;

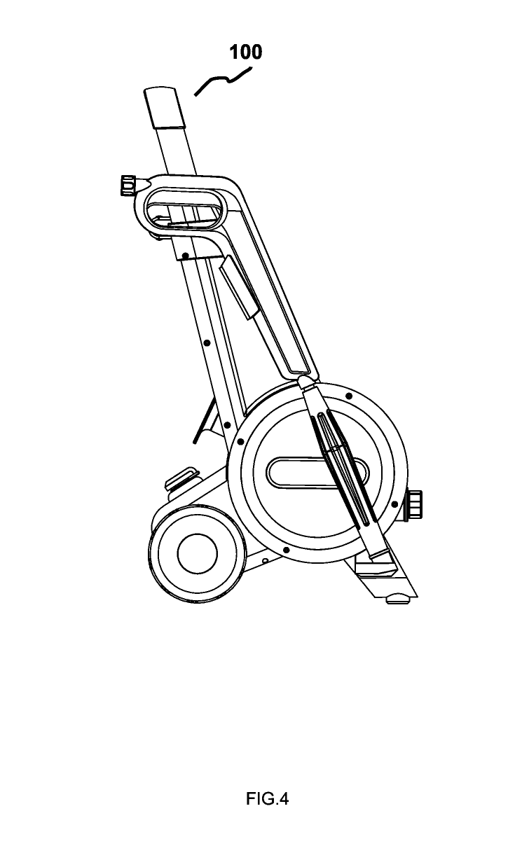

FIG. 5 is a front view of the pressure washer being shown in use;

FIG. 6 is a rear view of the pressure washer;

FIG. 7 is a right side cross-sectional view of the pressure washer taken along the line D-D shown in FIG. 14;

FIG. 8 is a front cross-sectional view of the pressure washer taken along the line A-A shown in FIG. 3;

FIG. 9 is a front right perspective view of the pressure washer showing the components of the barrel in greater detail;

FIG. 10 is an isolated view of the components of the barrel in greater detail;

FIG. 11 is a left side cross-sectional view taken along the line B-B shown in FIG. 14;

FIG. 12 is a front right perspective cross-sectional view of the pressure washer taken along the line C-C shown in FIG. 14;

FIG. 13 is a right side cross-sectional view of the pressure washer taken along the line C-C shown in FIG. 14;

FIG. 14 is a front view of the pressure washer;

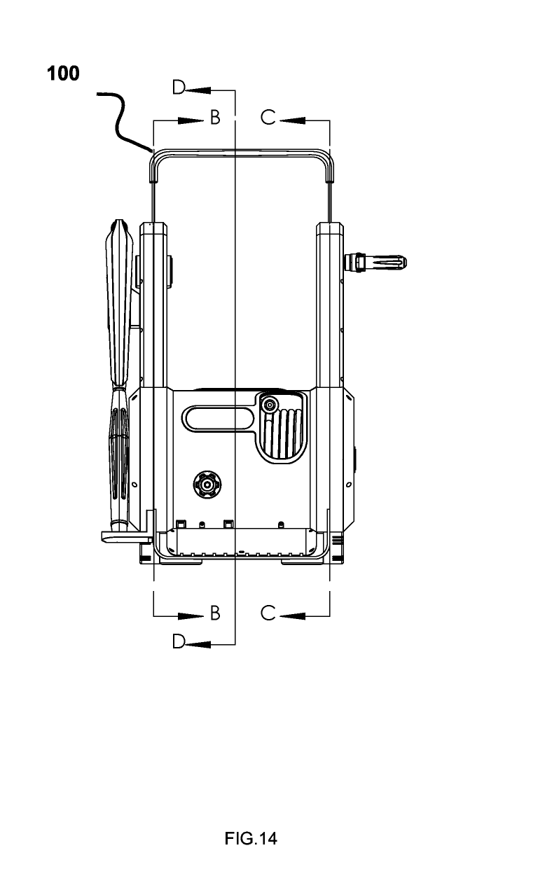

FIG. 15 is a rear perspective view of the pressure washer; and

FIG. 16 is a front perspective view of the pressure washer showing the reel support in greater detail.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The following provides a pressure washer with hose reel and motor pump assembly. The hose reel and motor pump assembly are disposed in a side by side arrangement within a barrel of the pressure washer so as to provide a low centre of gravity while accommodating a suitably long hose, and to provide substantial horizontal weight balance, both of which provide stability to the pressure washer when in use.

It will be appreciated that the following pressure washer could alternatively be used as a pumping apparatus wherein fluid is input from a fluid reservoir and pumped to a desired location.

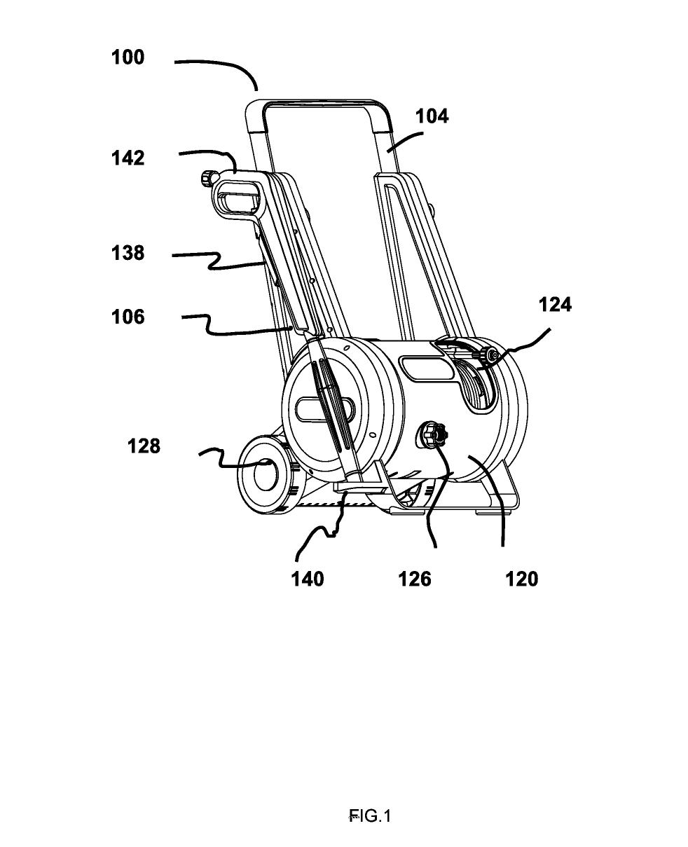

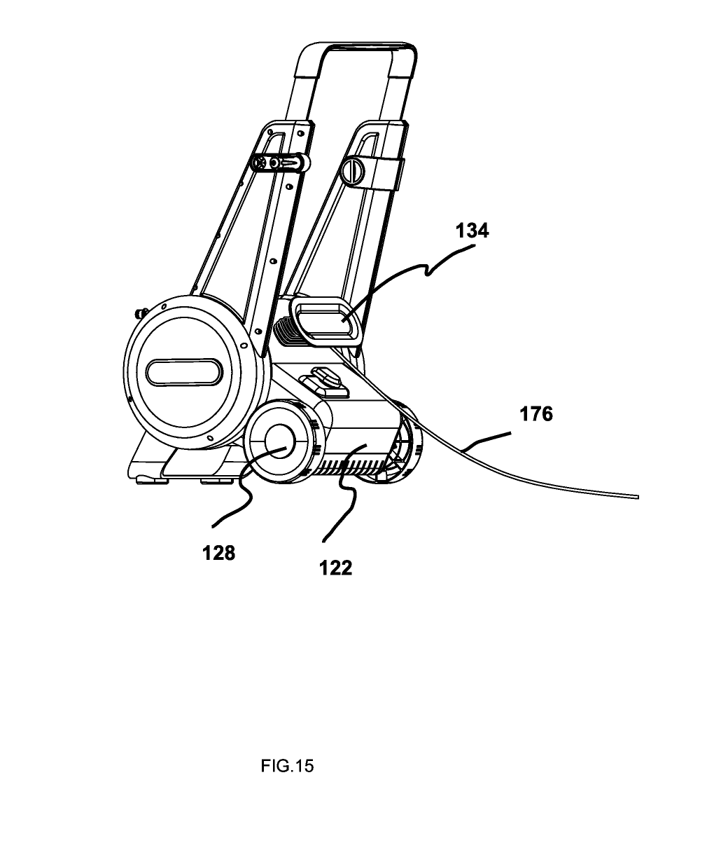

Referring first to FIGS. 1, 2 and 15, perspective views of an embodiment of the pressure washer (100) show a hose (102) extending therefrom. The pressure washer shown comprises a frame (104) having two opposing side walls (106, 108) connected by an upper crossbar (110), a lower crossbar (112) and a barrel (114). The side walls (106, 108) are substantially triangular with the base (116) of the side walls (106, 108) being wider than the apex (118) of the side walls (106, 108).

The barrel (114) comprises two portions, a first portion being a generally cylindrical portion (120) along its upper rear, upper front and lower front quadrants, and a second portion being a housing (122) extending from the lower rear quadrant of the cylinder. The barrel comprises an aperture (124) along its front surface through which the hose (102) may be accessed. The aperture (124) may be disposed along the upper front quadrant of the barrel (114). In this embodiment, the hose (102) may be pulled from the barrel (114) without tipping the pressure washer (100) rearward, which could for example occur if the hose (102) was alternatively accessed if the aperture was disposed along the bottom of the barrel (114) and the hose (102) is jerked in a direction away from the barrel. The barrel (114) further comprises a fluid inlet coupling (126). The fluid inlet coupling (126) is shown disposed along the front surface of the barrel (114), but could be located along any surface thereof.

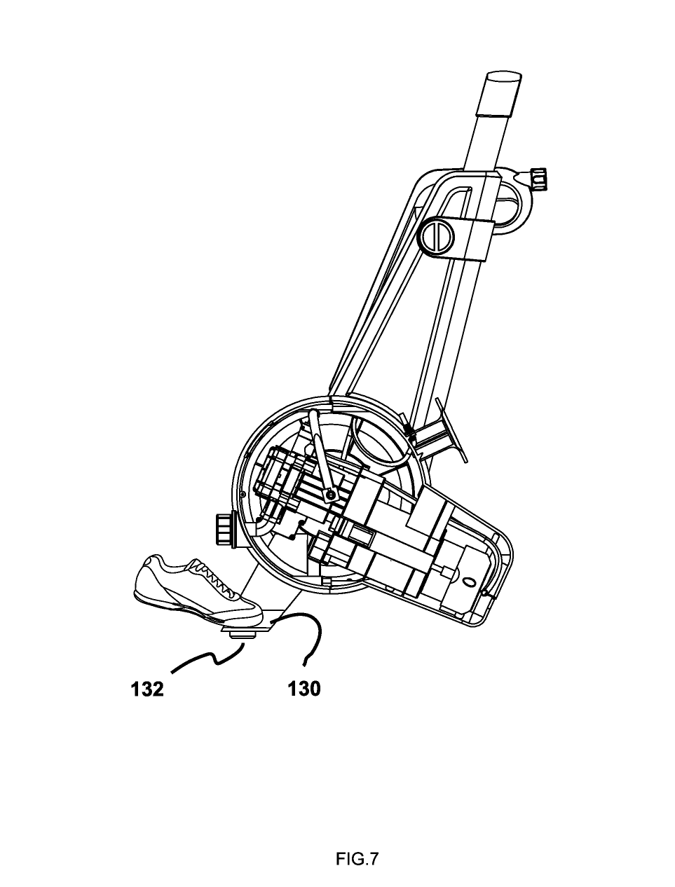

A pair of coaxial rear wheels (128) extends from the sides of the housing (122). In use, the frame (104) is supported by the pair of wheels (128) and lower crossbar (112). The upper crossbar (110) serves as a handle. The wheels (128) may be located at approximately the left and right extents of the frame (104) to maximize stability. A user can transport the pressure washer (100) by tilting the pressure washer along the wheels' axis to raise the lower crossbar (112) from the ground, and subsequently rolling the pressure washer (100) to a desired location. In alternative embodiments, the rear wheels (128) may be dispensed with, resulting in a less easily transportable pressure washer which may rest upon the lower surface of the housing, or could be a single or plurality of wheels. The lower crossbar (112) may alternatively be replaced by wheels, providing a four-wheeled pressure washer, or by a plurality of legs. The lower crossbar (112) may comprise a substantially flat upper surface (130), providing a convenient location for a user to rest her foot to prevent movement of the pressure washer while reeling or unreeling the hose, as shown in FIG. 7. As shown, the lower crossbar (112) may further have a plurality of resting pads (132) having disposed along its bottom surface for additional frictional engagement with the ground. The resting pads (132) are preferably compressible and have a bottom surface providing such frictional engagement.

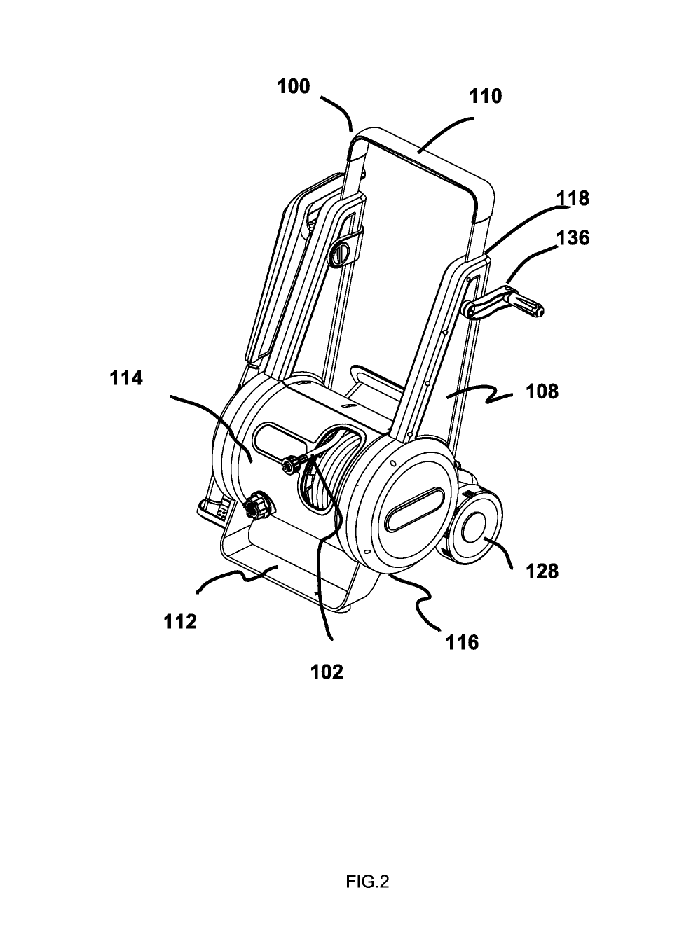

Referring again to FIGS. 1 and 2, the upper crossbar (110) extends from one side wall (106) to the other side wall (108). However, the upper crossbar (11) may alternatively be replaced by left and right handles, each extending from one or the other of the side walls (106, 108). Optionally, handles could be dispensed with altogether provided that the frame (104) is grippable by a user in such a way as to enable the user to transport the pressure washer (100). In embodiments, the upper crossbar is elongated at its ends to enable the upper crossbar to be slidably engaged to the frame such that it can be extended and retracted substantially vertically from the frame.

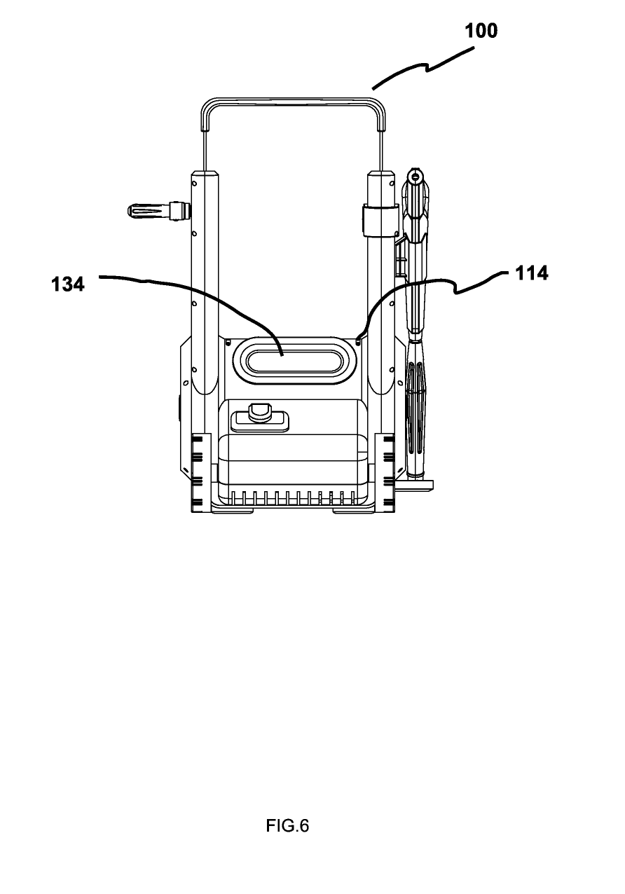

Referring now to FIG. 6, a cord reel (134) is disposed upon the upper rear quadrant of the barrel (114) for winding an electrical cord (176). The cord reel (134) shown is oblong and of sufficient width to allow the cord to be fully wrapped without becoming bulky (i.e., without requiring the user to loop the cord an unreasonable high number of loops).

Referring again to FIGS. 1 and 2, a crank (136) is disposed upon one of the side walls (108). A spray gun holster (138) is disposed upon the other of the side walls (106). Optionally, a spray gun rest (140) is disposed along the same side wall (106) as the holster (138) such that a free end of a spray gun (142) rests against the spray gun rest (140) while in the holster (138). The crank (136) and holster (138) may be disposed proximate the handle (110) end of the frame (104) so that they are more comfortably accessible by a user. More specifically, both the crank (136) and the spray gun holster (138) may be disposed at a distance suitable for use by a user with minimal discomfort, such as approximately waist to elbow height of a typical user.

As can be seen throughout the figures, the barrel (114) is disposed relatively low to the ground; that is, closer to the lower crossbar (112) than to the upper crossbar (110). In embodiments, the cylindrical portion (120) of the barrel (114) has minimal ground clearance when the pressure washer rests on the wheels (128) and lower crossbar (112). The cylindrical portion (120) of the barrel (114) houses the hose reel, a hose disposed around the hose reel and an upper portion of the motor pump assembly, while the housing portion (122) of the barrel (114) houses a lower portion of the motor pump assembly and a detergent reservoir. As will be appreciated, the hose reel, hose, motor pump assembly and detergent reservoir are likely to comprise the majority of the weight of the pressure washer and, therefore, having the barrel (114) substantially low to the ground enables the pressure washer (100) to have a low centre of gravity.

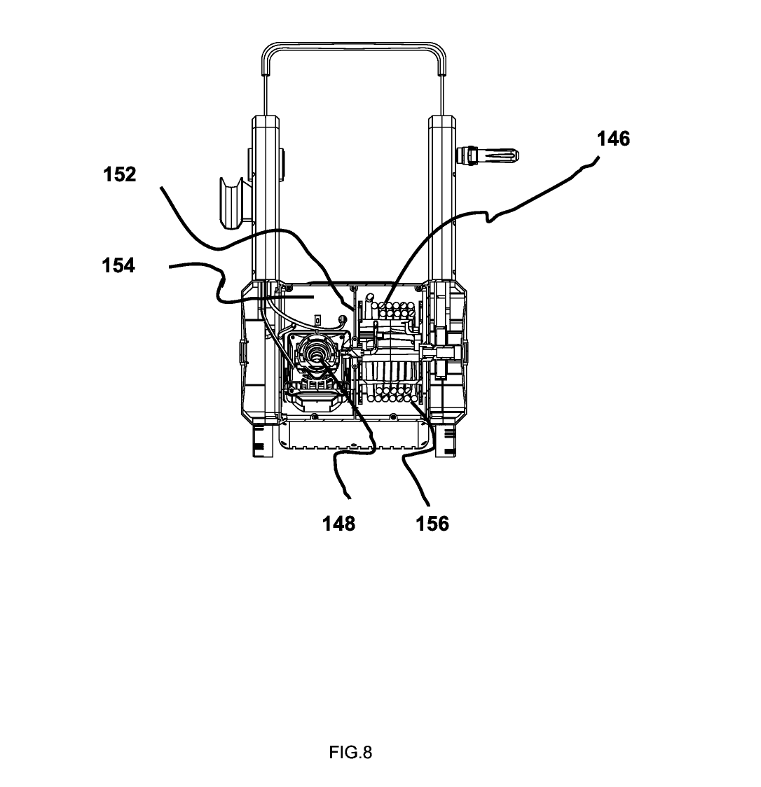

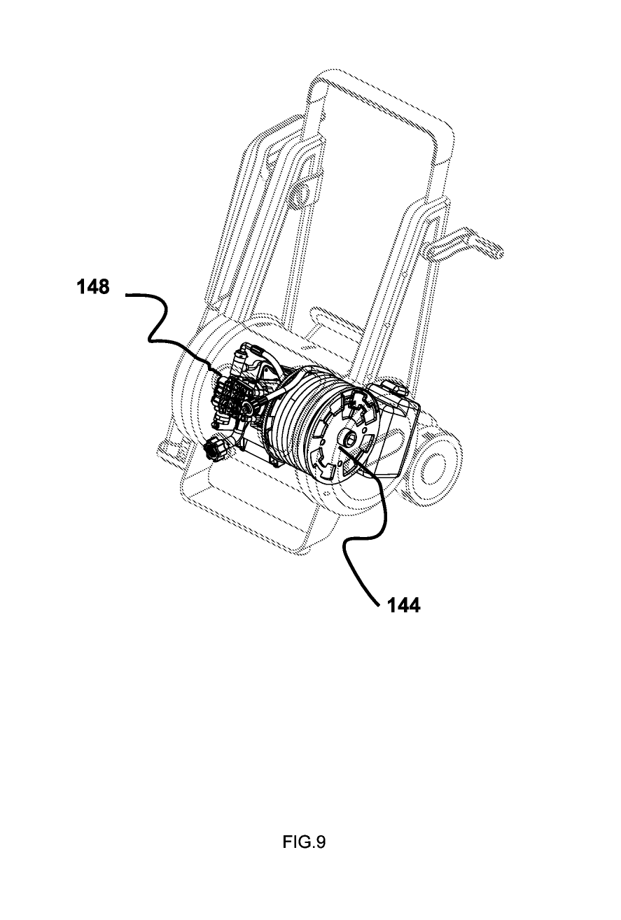

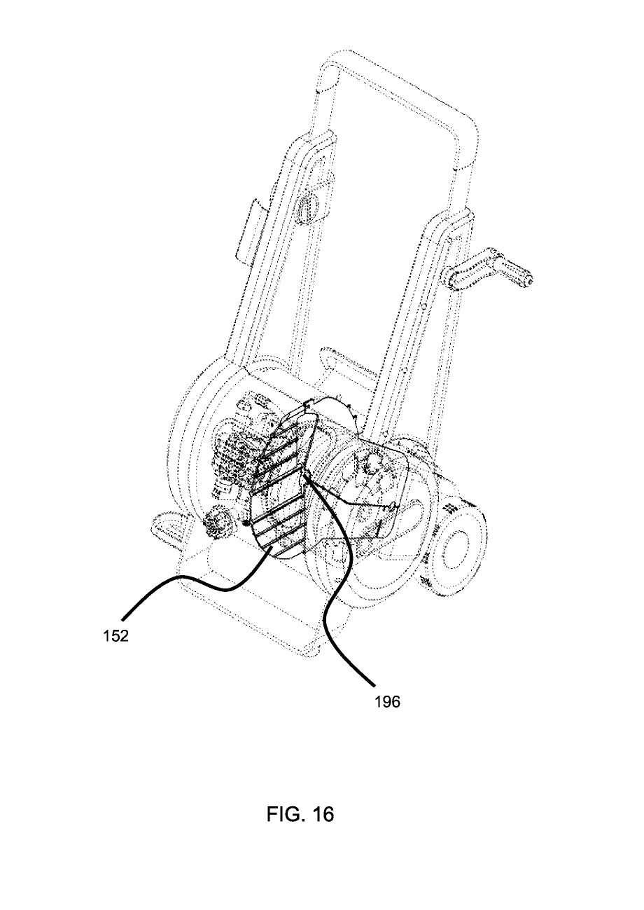

Referring now to FIGS. 8, 9, 10 and 16, the hose reel (144), hose (146), motor pump assembly (148) and detergent reservoir (150) can be seen. The cylindrical portion (120) of the barrel (114) comprises a reel support (152) disposed part-way between the two side walls of the frame (106, 108). The reel support (152) defines two chambers (which need not be fully separated from one another), wherein a first chamber (154) houses the motor pump assembly (148) and the second chamber (156) houses the hose reel (144). In the embodiment shown, the reel support (152) is a dividing wall that divides the barrel approximately in half, however the dividing wall could be relatively closer to either one of the side walls (106, 108) of the frame. Such an arrangement may, for example, be desirable for a larger or smaller motor pump assembly (148) or a longer or shorter length of hose (146) which may require a wider or narrower width of hose reel (144), respectively. The dividing wall (152) has a supporting mechanism, which is shown as a central aperture (196) disposed therethrough, the purpose of which will now become apparent. Other embodiments of a suitable reel support (152) includes an elongate support having a central aperture or open-ended supporting mechanism (such as generally U-shaped rest), the reel support extending from one or opposing inner surfaces of the cylinder.

The hose reel (144) comprises a central cylinder (158) with two circular side walls (160). A hose (146) can be reeled onto and unreeled from the central cylinder (158) and held in place between the side walls (160). The central cylinder (158) rotates around a central axis defined by hubs (162, 164) extending outwardly from the side walls. One hub (162) extends into a bore (not shown) defined in an inner surface of one of the side walls (106, 108) of the frame, while the other hub (164) extends through the central aperture (196) of the reel support (152). The latter hub (164) has disposed therethough a pipe (166) that extends from the hub through to a second opening (168) extending through an aperture (194) of the cylinder (158) and mated to (or integral with) the hose (146), permitting fluid communication therethrough. A rotary coupling (170) is attached to the pipe opening at the hub (164).

A motor pump assembly (148) comprises an electric motor (172) driving a pressurizing fluid pump (174). The motor (172) is powered by electricity obtained via the electrical cord (176), while fluid is provided to the pump (174) from a fluid source (not shown) coupled to the fluid inlet coupling (126). The fluid inlet coupling (126) may be selected, for example, to mate to a common garden hose. The pump (174) pressurizes the fluid and outputs the pressurized fluid to a pump outlet (178). A first conduit (180) is connected to the pump outlet (178) at one end and the rotary coupling (170) at the other end, permitting fluid communication from the pump outlet (178) to the rotary coupling (170), through the pipe (166) and to the hose (146).

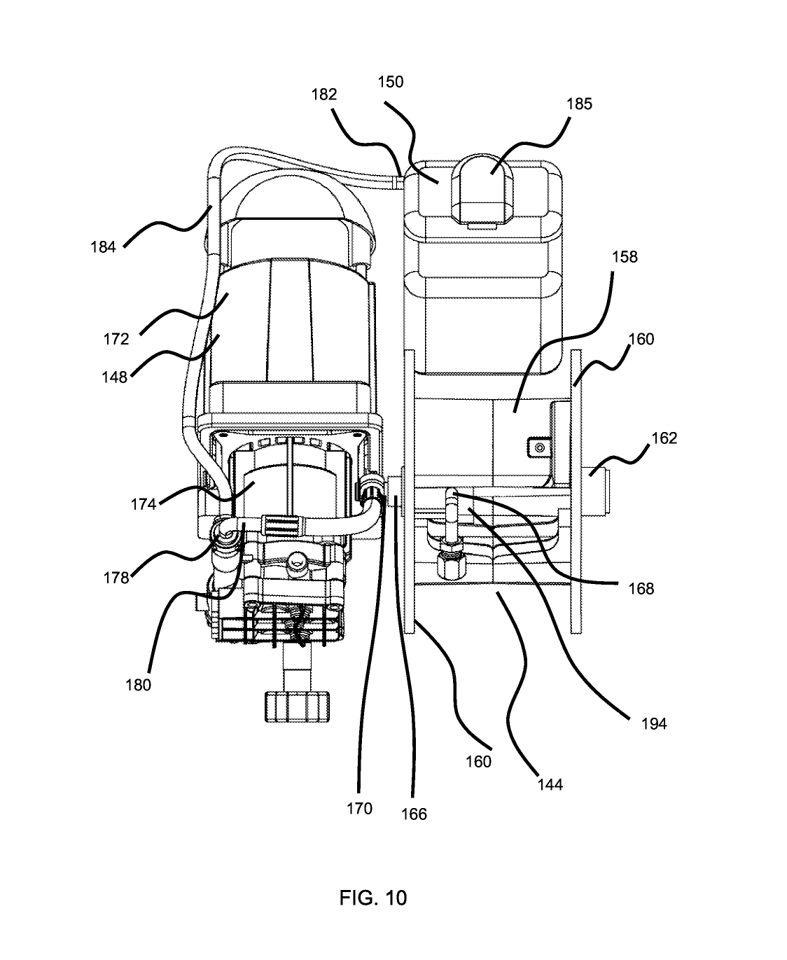

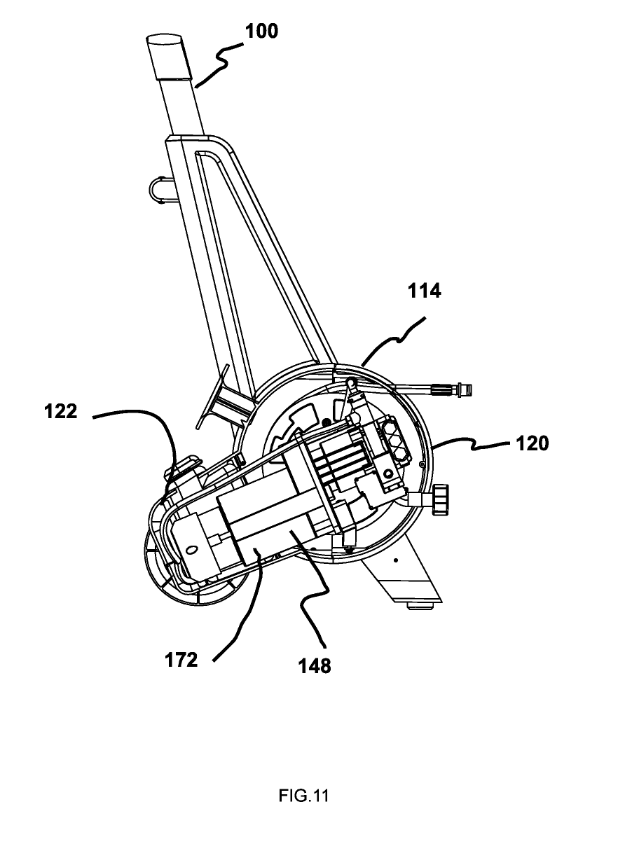

As is shown in FIGS. 10 and 11, the motor pump assembly (148) is mounted transversely to the hose reel (144) axis. In an example, a motor pump assembly (148) suitable for household outdoor use pressurizes fluid at between 1500 and 1800 pounds per square inch, though other fluid pressurization ranges are contemplated herein. Typically, a motor pump assembly (148) providing suitable fluid pressurization will be substantially long that it may not be feasible to mount it longitudinally with the hose reel (144) axis while still leaving sufficient space (width) for a hose reel and maintaining a suitably narrow pressure washer. However, it is preferred that the motor pump assembly (148) be disposed such that its centre of gravity is of a height as near to, or below, the centre of gravity of the hose reel (144) as possible, in order to provide optimal stability to the pressure washer. To accommodate a motor pump assembly (148) of such a length, the rear portion of the motor pump assembly (148) is disposed in the housing (122) adjacent to the detergent reservoir (150) and proximate one of the wheels (128). As can be seen particularly in FIG. 11, the motor pump assembly (148) may be mounted at an angle such that it is not disposed horizontally when viewed from the side. In such an embodiment, the portion of the motor pump assembly disposed in the housing may be adjacent to the wheels, such that it is disposed as low as possible within the pressure washer.

The detergent reservoir (150) is disposed proximate the other one of the wheels (128). The detergent reservoir (150) comprises an outlet (182) coupled by a second conduit (184) to the first conduit (180), wherein detergent pulled from the reservoir (150) by fluid pressure is mixed with the pressurized fluid. A user can add detergent to the detergent reservoir (150) using detergent cap (185), which may be a rubberized cap having an integral gasket forming a watertight seal on the detergent reservoir.

Thus, the hose reel (144), hose (146), motor pump assembly (148) and detergent reservoir (150) are disposed in the barrel so as to provide substantially balanced weight from left to right in both the cylindrical portion (120) and the housing portion (122) of the barrel (114). The barrel (114) as a whole is disposed as low as possible to enable the pressure washer (100) to have a low centre of gravity.

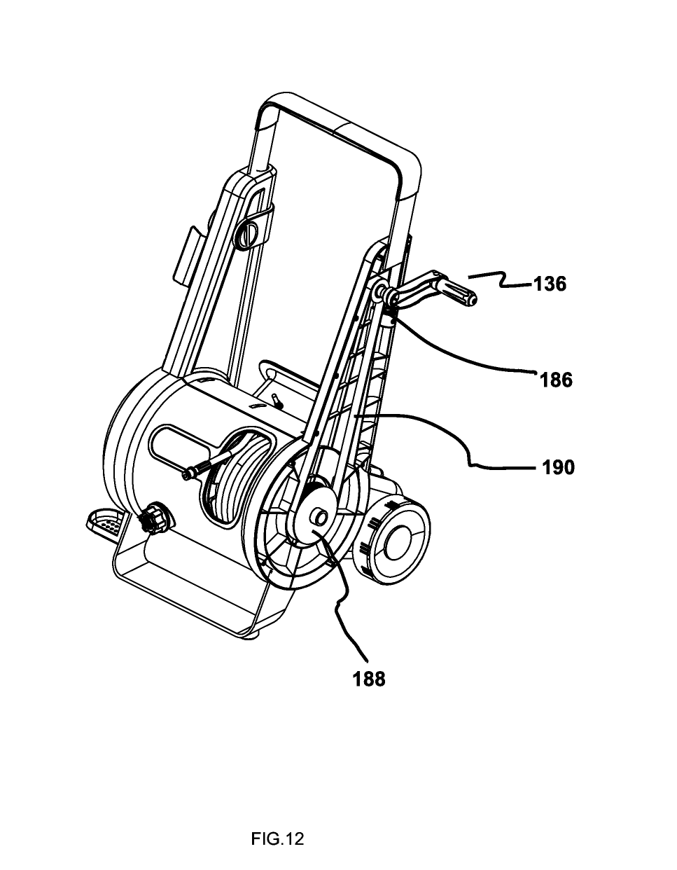

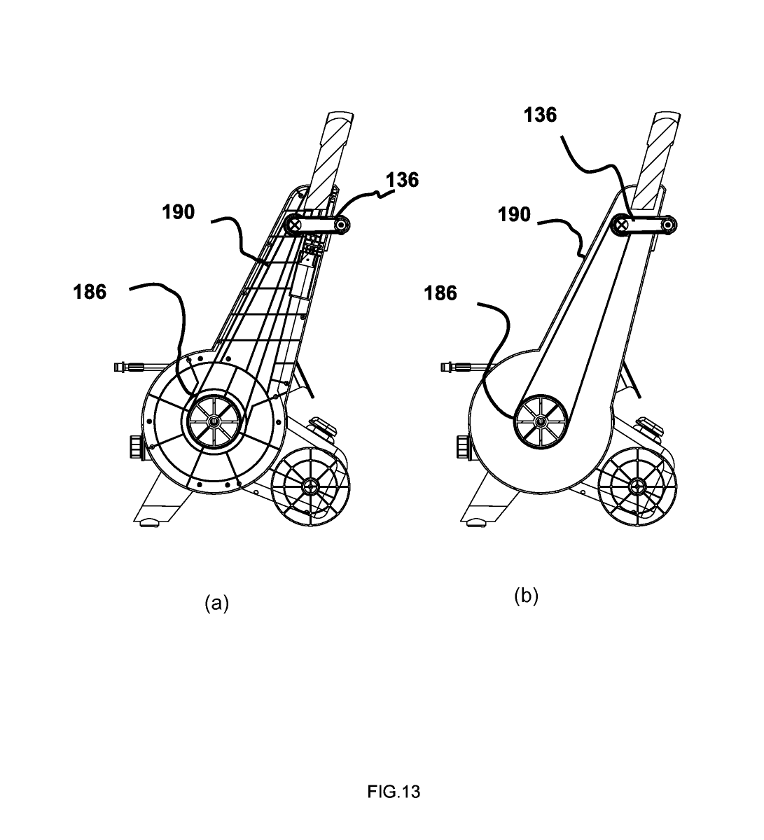

With the hose reel (144) disposed sufficiently low in the frame, the crank may be mounted at a more comfortable height and coupled to the hose reel (144) to turn the hose reel (144). Referring now to FIGS. 12 and 13, the operation of the crank (136) becomes apparent. FIG. 13a shows a cross-sectional view of the right side wall (106) while FIG. 13b shows a similar view without ribbing in the structure. It will be understood that ribbing provides structural rigidity to the structure where it is formed by a plastic.

The crank (136) may be coupled to the hose reel by a pulley apparatus comprising a crank pulley (186) coaxial with the crank (136), a drum pulley (188) coaxial with the hose reel (144) and a belt (190) coupling the crank pulley (186) to the drum pulley (188). The belt (190) may be a flexible or non-flexible belt or chain. Given the weight of the hose, the crank pulley (186) may have a substantially lower radius than the hose pulley (188) to allow a user to turn the crank pulley (186) without significant physical exertion.

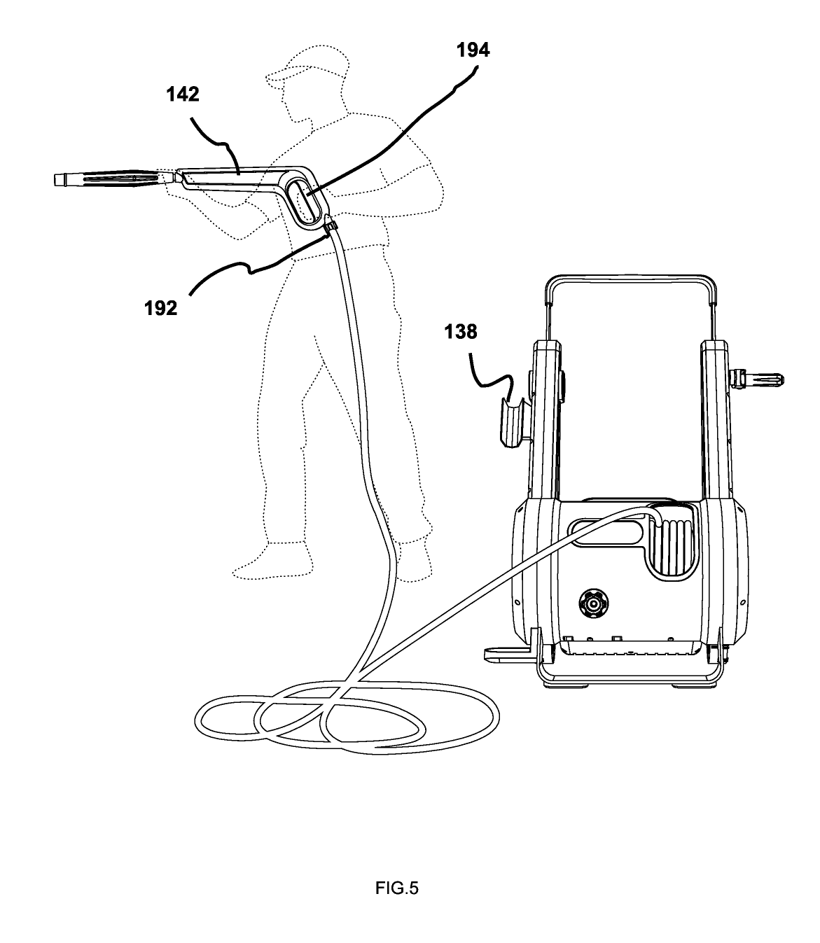

Referring back to FIGS. 1 and 2, the spray gun (142) may be removably mounted to the holster (138). The spray gun (142) is shown removed from the holster in FIG. 5. The spray gun (142) may comprise a coupling (192) for attaching a hose, which may be the hose (146) reeled on the hose reel (144) or an intermediate hose (not shown) coupling the spray gun (142) to the hose (146) on the hose reel (144). The spray gun (142) may comprise a trigger (192) operating a valve (not shown) enabling selective pressurized fluid communication through the spray gun (142).

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

We claim:

1. A pressure washer comprising:
a) a frame comprising two side walls joined by a barrel, the barrel comprising a reel support defining a first chamber and a second chamber of said barrel;
b) a fluid inlet for receiving fluid;
c) a motor pump assembly disposed within said first chamber, said motor pump assembly in fluid communication with said fluid inlet, said motor pump assembly operable to pressurize said fluid and output pressurized fluid to a pump outlet; and
d) a hose reel disposed within said second chamber, said hose reel being rotatable about an axis defined by a supporting mechanism of said reel support, said hose reel and said motor pump being disposed transversely to one another.

2. The pressure washer of claim 1, wherein said hose reel has an aperture in fluid communication with said pump outlet, said aperture adapted to permit a hose to be coupled thereto.

3. The pressure washer of claim 1, wherein said barrel comprises a cylindrical portion and a housing portion disposed behind said cylindrical portion, said motor pump assembly being disposed partially within said cylindrical portion and partially with said housing portion.

4. The pressure washer of claim 3, wherein said pressure washer further comprises a pair of coaxial wheels disposed on opposing sides of said housing portion.

5. The pressure washer of claim 1, wherein one of two side walls comprises a crank coupled to said hose reel, said crank being rotatable to rotate said hose reel.

6. The pressure washer of claim 5, wherein said crank is coupled to said hose reel by a belt coupling a crank pulley, said crank pulley coaxial with said crank, and a drum pulley, said drum pulley coaxial with said hose reel.

7. The pressure washer of claim 1, wherein one of said two side walls comprises a holster for removably mounting a spray gun capable of being coupled to said hose to permit fluid communication therefrom.

8. The pressure washer of claim 1, wherein said frame is further joined by a lower crossbar, said pressure washer resting upon said lower crossbar when not being transported.

9. The pressure washer of claim 8, wherein said lower crossbar has a substantially flat upper surface.

10. The pressure washer of claim 1, wherein said frame is further joined by an upper crossbar, said upper crossbar being grippable by a user to transport said pressure washer.

11. The pressure washer of claim 10, wherein said upper crossbar is slidable relative to said frame.

12. The pressure washer of claim 3, wherein said pressure washer further comprises a detergent reservoir disposed within said housing portion adjacent to said portion of said motor pump assembly.

13. The pressure washer of claim 1, wherein a cable reel is disposed along a surface of said barrel for reeling an electrical cord.

14. The pressure washer of claim 1, wherein said barrel is disposed substantially low to the ground when said pressure washer is not in transport.

15. The pressure washer of claim 1, wherein said motor pump assembly is disposed within said first chamber and said hose reel is disposed within said second chamber to provide substantial weight balance when said hose reel is equipped with a hose.
